(19) United States
(12) Patent Application Publication
(10) Pub. No.: US 2018/0061146 A1
(43) Pub. Date: Mar. 1, 2018

(54) AUTOMOBILE INFORMATION BEACON

(71) Applicant: Wal-Mart Stores, Inc., Bentonville, AR (US)

(72) Inventors: Brian Bode, Bentonville, AR (US); John Paul Thompson, Bentonville, AR (US)

(21) Appl. No.: 15/659,843

(22) Filed: Jul. 26, 2017

Related U.S. Application Data
(60) Provisional application No. 62/378,475, filed on Aug. 23, 2016.

(51) Int. Cl. G07C 5/00; G07C 5/08

(52) U.S. Cl. CPC G07C 5/006; G07C 5/085; G07C 5/008

(57) ABSTRACT

A small, self-contained, inexpensive, vehicle maintenance system has a vehicle unit that stores and retrieves maintenance information about a vehicle. The vehicle unit mounts on the inside of a vehicle's windshield and employs a solar panel to power it. The vehicle unit stores the vehicle maintenance information in an internal nonvolatile memory. The vehicle unit employs standard wireless technology to communicate with external computing devices such as a smart phone or tablet. The vehicle unit employs open architecture to allow various mechanics to access the stored maintenance information of the vehicle and various other information such as the type of oil being used, the past history and replacement part numbers. The vehicle unit also may receive information from the external computing device to store current information and add it to the maintenance history. The vehicle unit may also employ sensors and a communication device that can notify the driver when the vehicle has entered and exited maintenance bay.

### RELATED APPLICATIONS

This application claims the benefit of U.S. Provisional Patent No. 62/378,475, filed Aug. 23, 2016, entitled “Automobile Information Beacon,” the contents of which are incorporated by reference herein in their entirety.

### FIELD

Aspects of the present invention relate to a self-contained system for aiding in the maintenance of a vehicle, and more specifically for a self-contained system for aiding in the maintenance of a vehicle by storing and recalling past maintenance records and notifying the driver when the maintenance begins and ends.

### BACKGROUND

Vehicles such as automobiles and trucks, receive periodic maintenance, such as oil changes. It is common to keep track of the last oil change by writing it on a sticker and placing the sticker on the inside of the vehicle windshield. Typically, the information only indicates the date and mileage of the next scheduled oil change. Some oil change companies track the past oil changes along with other information; however, this is manually entered into the oil change company's computer, and the driver has no access to this information.

Also, this information is not shared between the different companies that perform maintenance on the same vehicle. Each time the driver brings his/her vehicle to a different oil company, an employee at the company has to manually input information about the car being serviced, since the companies do not share the information. This information is also not available to the driver, except for a portion of the information that is provided in the form of a printed report. Therefore, if the driver takes his vehicle to several different oil change companies for maintenance, the maintenance records are scattered among these oil change companies. Even if the driver was to accumulate the information from the various oil change companies, the information is most likely in various incompatible formats.

When the driver takes his/her vehicle to get serviced, there is usually a waiting line. Typically, the driver meets with a maintenance person (mechanic), provides information on the vehicle, selects what type of services to be performed, and then leaves the vehicle to get serviced. Since it may take some time before the vehicle is finished, the driver may go somewhere and check back to see if the vehicle is finished. In the case that is finished early, and the company employees are busy, and do not notify the driver his/her vehicle is finished, the driver may be wasting time needlessly, believing that the vehicle is still waiting to be serviced.

It would save a great deal of wasted time if the driver knew precisely when the vehicle begins being serviced, and when the service has been completed.

Currently, there is a need for a system which easily provides past maintenance records and also notifies the driver when his/her vehicle begins and completes maintenance servicing.

### BRIEF SUMMARY

According to aspects of the present inventive concepts there is provided an apparatus and method as set forth in the appended claims. Other features of the inventive concepts will be apparent from the dependent claims, and the description which follows.

In one example, there is described a self-contained vehicle maintenance device for assisting a driver of a vehicle with its maintenance, employs a solar panel mounted in a position to receive light energy through a window of the vehicle, a housing for securing the solar panel, a power source within the housing adapted to receive electronic energy from the solar panel charging it, wherein the power source powers all elements of the vehicle maintenance device.

The vehicle maintenance device also includes a memory module within the housing also has prestored executable programs and vehicle information, at least one motion sensor within the housing, a transceiver within the housing, adapted to communicate with at least one computing device external to the maintenance device.

It also includes a processor within the housing, coupled to the power source, the memory and the transceiver, adapted to run the prestored executable code and function to read the at least one sensor to detect if the vehicle has moved, and provide a notification through the transceiver to the driver that the vehicle has moved. The processor also functions to receive requests through the transceiver to provide stored vehicle information, retrieve the requested vehicle information stored in the memory, and send the retrieved vehicle information through the transceiver to the external computing device. Since it sends the information wirelessly, it resembles a beacon and is referred to as an ‘automobile information beacon’ or ‘auto info beacon’.

In another example there is described a method of maintaining a vehicle by attaching a self-contained, self-powered maintenance device to a windshield of the vehicle which may be accessed from outside of the vehicle, that is capable of receiving vehicle information, storing the vehicle information, communicating wirelessly with an external computing device to receive a request to retrieve portions of the stored vehicle information, and retrieve the requested vehicle information. The retrieved information is then provided to external computing device.

The system according to one embodiment of the current invention may be described as a vehicle maintenance system for assisting a driver of a vehicle with its maintenance, having an external computing device, electronic markers marking the maintenance area, and a vehicle mounted unit adapted to communicate wirelessly with the external computing device. The vehicle mounted unit has a solar panel mounted in a position to receive light energy through a window of the vehicle. A power source is adapted to receive electronic energy from the solar panel charging it, wherein the power source powers all elements of the vehicle maintenance system. The vehicle mounted unit also employs a memory module having prestored executable programs and vehicle information, at least one sensor that can sense the presence of an electronic marker, a transceiver, adapted to communicate with the external computing device and a processor adapted to run the prestored executable programs. The processor functions to read at least one sensor to detect if the vehicle has moved into the maintenance area, and provide a notification through the transceiver to the driver that the vehicle has moved into the maintenance area. The processor also receives request through the transceiver to provide stored vehicle information, retrieves the requested vehicle information stored in the memory, and sends the retrieved vehicle information through the transceiver to the external computing device.

### BRIEF DESCRIPTION OF SEVERAL VIEWS OF THE DRAWINGS

The above and further advantages may be better understood by referring to the following description in conjunction with the accompanying drawings, in which like numerals indicate like structural elements and features in various figures. The drawings are not necessarily to scale; emphasis instead being placed upon illustrating the principles of the concepts. For example, the dimensions of some of the elements in the figures may be exaggerated relative to other elements to help to improve understanding of various example embodiments. Also, common but well-understood elements that are useful or necessary in a commercially feasible embodiment are often not depicted in order to facilitate a less obstructed view of these various example embodiments.

FIG. 1 illustrates an overall block diagram of one embodiment of a vehicle maintenance system in accordance with the present invention.

FIG. 2 illustrates a plan view of the vehicle unit of the system of FIG. 1 showing the solar panel and other parts.

FIG. 3 is an illustration of the vehicle unit of FIG. 1 attached to a windshield.

FIG. 4 is a schematic block diagram of the vehicle unit of FIG. 1 showing its major functional parts.

FIG. 5 is a modified flow chart illustrating the functioning of one embodiment of the vehicle maintenance system in accordance with one aspect of the present invention.

### DETAILED DESCRIPTION

As indicated above, the maintenance records for most vehicles are scattered among several companies that have performed maintenance on the vehicle in the past. The novel ‘auto info beacon’ described in this application, which may also be referred to as a vehicle maintenance system, accumulates this information in a standard open format that can be used by any, or all companies which perform maintenance on the vehicle. It allows a full set of maintenance information to be available to all companies performing maintenance on the vehicle.

The vehicle unit of the vehicle maintenance system employs a simple, inexpensive, self-contained device having a small form factor that is attached to the windshield or is mounted hanging from the rear view mirror that stores and retrieves maintenance information of a vehicle.

### Simple

The vehicle unit of the vehicle maintenance system is simple since it does not have to interface with the electronics of the vehicle. This eliminates the need for the system to communicate in various formats for each of the various types of electronics used in different vehicles.

### Self-Contained

In its preferred embodiment, the vehicle unit of the vehicle maintenance system receives its power from solar cells, and does not require power wires to run to the vehicle. The vehicle maintenance system uses inexpensive solar powered technology. It employs wireless communications, so it does not require wires to communicate, and therefore can be self-contained.

### Installation

The vehicle maintenance unit does not require special mounting and in its preferred embodiment can be held to the vehicle's windshield with an adhesive. It may also be attached to the rearview mirror.

Also, as indicated above, it does not require power wires, communication wires, or wires to interface with the vehicle electronics. Therefore, it does not require extensive installation.

### Wireless Communication

In its preferred embodiment, it is designed to communicate with external computing devices using Bluetooth wireless communication, near field communication (NFC), or other industry-standard wireless communication. Therefore, it can receive communication and transmit data without requiring any other connections. The vehicle maintenance system is designed to use industry-standard Bluetooth communications allowing to be accessed by smart phones, tablets, and computers with Bluetooth functionality. Also, it is designed to use open platform architecture to allow other auto service companies/mechanics to adopt/access the vehicle maintenance system. Therefore, a mechanic does not require any additional equipment to interface with the invention.

### Inexpensive

Since it can use standard off-the-shelf parts and standard communication protocol, the vehicle maintenance system should not be expensive to build.

The vehicle maintenance system exhibits various features and advantages such as those below.
1. Oil change records are written to and retrieved from memory of the vehicle maintenance system.
2. Other maintenance records, such as belt replacement, tire replacement, battery replacement, wiper blade replacement, etc. could also be stored in the memory of the vehicle maintenance system for later retrieval.
3. If made tamper-proof, maintenance records could be used to indicate how a vehicle has been maintained over its history. This would allow one, such as a potential buyer, to acquire a quick snapshot of how the vehicle has been maintained.
4. The vehicle maintenance system can be used with any vehicle type, regardless of the existing technological state of the vehicle, since it does not need to interface with the vehicle electronics.
5. Maintenance records are accessible to almost any mechanic using a basic smartphone running a downloaded app since standard communication formats and open architecture are implemented in the current system.
6. The vehicle maintenance system has the capability of notifying customers when their car moves into the maintenance bay and when it is taken out of the maintenance bay.
   Elements of the vehicle unit 1100 of the vehicle maintenance system 1000 are listed below.
1. The vehicle unit 1100 of the vehicle maintenance system 1000 can employ a small form factor (such as fitting into a one-half inch thick and 2″ by 2″ square plastic housing 1110).
2. The vehicle unit 1100 can employ a readable/writeable memory chip 1160 which is preferably non-volatile memory.
3. The vehicle unit 1100 can stick to the inside of the windshield 11 or hang from the vehicle's interior rear-view mirror. Therefore, there is no mounting required.
4. The vehicle unit 1100 is powered by a rechargeable power source 1130, which may be a rechargeable battery, capacitor, bank of capacitors or supercapacitor that is charged by the solar panel 1120. In an alternative embodiment, a weight which moves with the movement of the vehicle, can be used to create electricity. The constant motion may be used to charge the power source in addition to, or instead of the solar panel. This may be implemented in areas which do not have enough sunlight.
5. The vehicle unit 1100 employs a transceiver 1140 which preferably communicates, exchanges data, and shares functionality with the mechanic's computing device 1200 preferably employing Bluetooth format.
6. The vehicle unit 1100 employs a small low-power microprocessor.
7. The vehicle unit 1100 may employ a motion sensor, such as an accelerometer to record vehicle speed over various intervals.
8. The vehicle unit 1100 also may employ other sensors, such as maintenance bay marker, temperature, and other sensors.
9. In an embodiment, the transceiver 1140 of vehicle unit 1100 also has the ability to communicate with the driver's computing device 1300 and have access to data and functionality of the driver's computing device 1300, such as the output of a GPS location App.

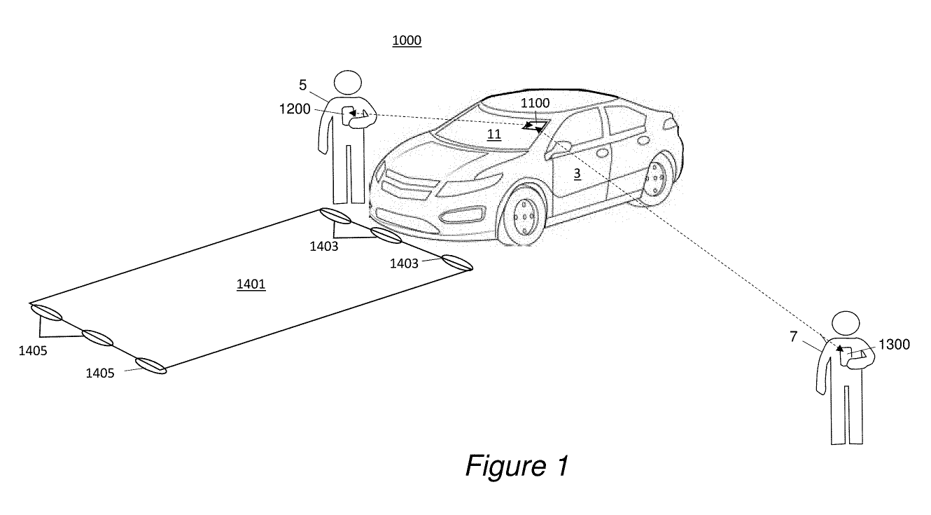

FIG. 1 illustrates an overall block diagram of one embodiment of a vehicle maintenance system 1000 in accordance with the present invention. A driver drives his/her vehicle 3 to a maintenance person, or mechanic 5 to be serviced. The servicing may be any type of maintenance that is performed on vehicle 3, which may be oil changes, replacing tires, rotating tires, replacing wipers, topping off fluids, replacing head and taillights, or any other typical maintenance required by automobiles. In this example, an embodiment of the current system will be described in connection with an oil change; however, it is understood that the spirit of the invention covers all maintenance to vehicles.

After the drivers 7 drops off the vehicle with mechanic 5, he indicates the type of service to be performed and provides contact information. The driver 7 can also indicate to mechanic 5 instructions on how to access a vehicle unit 1100 that is mounted in or on the vehicle 3. In its preferred embodiment, vehicle unit 1100 is attached to the windshield 12 such that it can be accessed by mechanic 5 through the windshield 11 of vehicle 3.

Vehicle unit 1100 has prestored history of maintenance that has been performed on vehicle 3. Vehicle unit 1100 may also include information indicating parts used for maintenance of vehicle 3. For example, vehicle unit 1100 may have the oil filter type, the preferred oil type used, the viscosity of the oil used, the manufacturer's specification suggesting the viscosity and type of oil to use, part numbers for headlight bulbs, tail light bulbs, tire size, PCV valve type and part number, filter part numbers, and, theoretically, any parts that may be replaced on the vehicle 3.

Vehicle unit 1100 may also store a history of which fluids have been topped off, tires which were low on pressure, and various other notes relating to the state of vehicle 3 during any of its past maintenance visits.

Since vehicle unit 1100 is designed to be an open system and accessible using standard communications formats, the information stored in vehicle unit 1100 could have been entered by various different vehicle maintenance entities.

Mechanic 5 uses a mechanic's computing device 1200, which may be a smart phone, tablet, or other computing device which has wireless communications capabilities that communicates through windshield 11 to vehicle unit 1100.

In a preferred embodiment, mechanic's computing device 1200 communicates with vehicle unit 1100 via Bluetooth communication. Other types of communication such as cellular, near field, Wi-Fi, or other currently known existing wireless communications technologies may also be used.

Mechanic 5, through mechanic's computing device 1200 can request any or all information stored in vehicle unit 1100. This information may then be displayed on a touchscreen 1201 of mechanic's computing device 1200. Mechanic 5 may also interact with vehicle unit 1100 by selecting buttons and/or providing other input to vehicle unit 1100 through touchscreen 1201 of mechanic's computing device 1200.

FIG. 1 also shows a maintenance bay 1401, being an area where the vehicle 3 will receive its service maintenance. This maintenance bay 1401 has at least one marker, being an entrance marker 1403 and/or an exit marker 1405. The vehicle unit 1100 has a at least one sensor capable of identifying when it has passed the entrance marker 1403, but has not yet passed the exit marker 1405 thereby indicating that it is within the maintenance bay 1401.

Since it can also sense when it passes the exit marker 1405, vehicle unit 1100 can determine when vehicle 3 has left the maintenance bay 1401.

Vehicle unit 1100 may optionally have the capability to send a notification to a driver's computing device 1300 which is held by driver 7. This notification can indicate when vehicle 3 has moved into maintenance bay 1401. It can also send a notification when vehicle 3 has exited maintenance bay 1401. In this embodiment, vehicle unit 1100 may require Wi-Fi, or cellular capability to provide text or an audible sound providing the proper notification to driver 7.

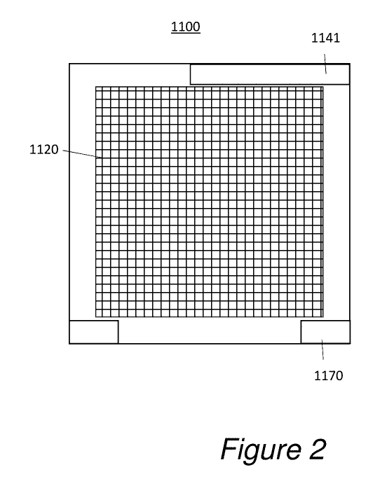

FIG. 2 illustrates a solar panel 1120 of an embodiment of the vehicle unit 1100 of the vehicle maintenance system 1000 of FIG. 1. This view shows the surface of the solar panel 1120 comprised of a plurality of solar cells that is intended to be attached to the inside of windshield 11 of vehicle 3 in FIG. 1. Solar panel 1120 receives sunlight and converts it to electrical power to power the vehicle unit 1100.

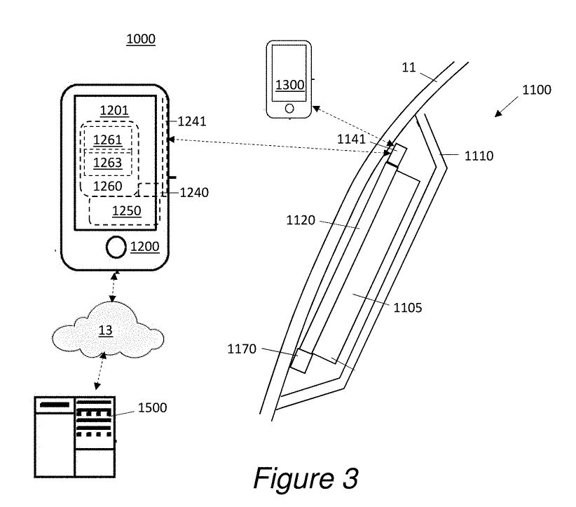

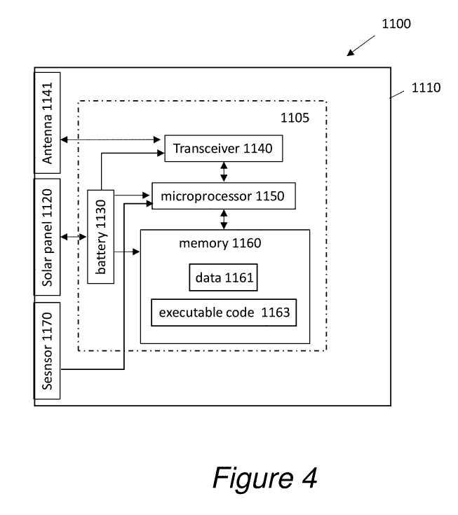

FIG. 3 is an illustration of the vehicle unit 1100 of FIG. 1 attached to a windshield. FIG. 4 is a schematic block diagram of the vehicle unit 1100 of FIG. 1 showing its major functional parts. The system of the current application will be explained now with reference to FIGS. 3 and 4.

It can be seen that solar panel 1120 attaches to or is held near windshield 11. Vehicle electronics are shown generally as 1105 in FIG. 3, but are shown in more detail in FIG. 4. A housing 1110 is attached to solar panel 1120 and closes the remaining parts of vehicle unit 1100.

Solar panel 1120 is coupled to and charges a rechargeable power source 1130. The power source 1130 powers remaining elements of vehicle unit 1100.

Vehicle unit 1100 has a memory 1160 which stores the information described above and also stores executable code. A microprocessor 1150 is coupled to memory 1160 in is able to run the executable code to access any data in memory, read, store, delete or change any data in memory 1160.

Microprocessor 1150 also interfaces with transceiver 1140 which communicates with mechanic's computing device 1200. Transceiver 1140 may require an antenna 1141 to transmit and receive signals from mechanic's computing device 1200, and, optionally, driver's computing device 1300.

Mechanic's computing device 1200 may be a standard smart phone, computing pad, or laptop which may include a touchscreen 1201 in which mechanic 5 may input information. Touchscreen 1201 also provides images to provide output to mechanic 5. Mechanic's computing device 1200 includes a microprocessor 1250 coupled to a memory 1260 which includes data in executable code 1263. This executable code 1263 may be an App which is downloaded through a network such as the Internet 13 from a server 1500.

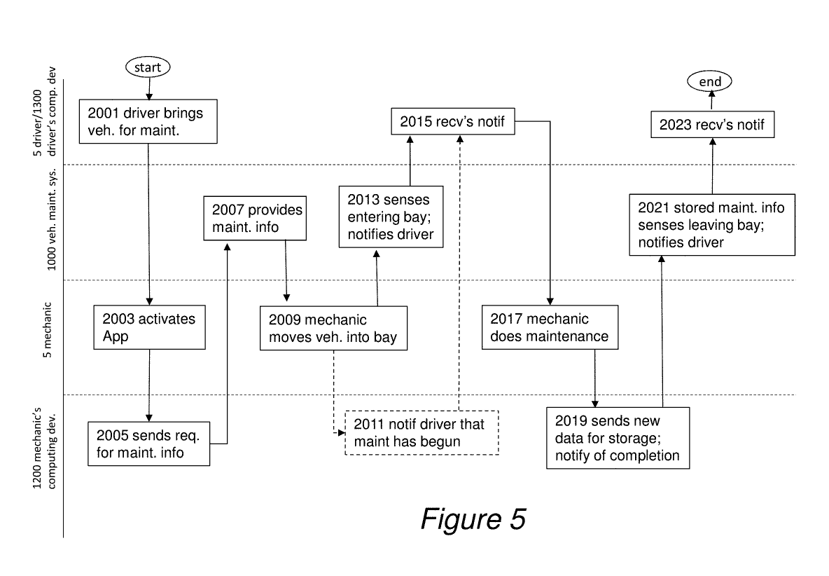

FIG. 5 is a modified flow chart illustrating the functioning of one embodiment of the vehicle maintenance system in accordance with one aspect of the present invention. The steps of the process will be described in connection with FIG. 4, and the parts of the system will be described in connection with FIGS. 1-3.

The process begins at step 2001 when the driver drives the vehicle 3 to a location that performs maintenance on vehicles, such as an oil change. The vehicle unit 1100 may determine when it is time for various maintenance procedures, such as an oil change and provide a notification to the driver through driver's computing device 1200. This is described further below.

In step 2003 a maintenance person, which may be a mechanic 5, activates a mechanic's computing device 1200 that interacts with the vehicle unit 1100. Mechanic 5, through mechanic's computing device 1200, provides input to mechanic's computing device 1200 to activate executable code 1163, which may be referred to a stored App that communicates with vehicle unit 1100.

As indicated above, mechanic's computing device 1200 may be a computing tablet, a laptop, or smart phone which has the capability to wirelessly communicate with vehicle unit 1100. In its preferred embodiment, it communicates with standard Bluetooth technology which is available on conventional computing tablets, laptops and smart phones.

In step 2005, mechanic 5, through mechanic's computing device 1200, requests previous oil change history information. This may include the date/mileage of previous oil changes, the oil type used, the viscosity of the oil used, oil filter type and part number used. It may also have the vehicle specifications which specify a recommended type of oil to use, viscosity, number of miles between oil changes, mileage between oil changes, and other information which may be helpful to the mechanic 5 performing maintenance on vehicle 3.

In step 2007, the vehicle unit 1100 provides the requested information to the mechanic's computing device 1200. This information may be used by the mechanic in selecting the preferred oil type, viscosity, and oil filter. The system may optionally have the capability of providing any other preferences or notes that may be helpful to mechanic 5 in servicing vehicle 3.

When it is time to work on the driver's vehicle 3, the mechanic 5 (or other person working in the maintenance facility) moves the vehicle 3 into the maintenance bay 1401 in step 2009. In this embodiment, mechanic's computing device 1200 notifies vehicle unit 1100 that it is beginning maintenance on vehicle 3 in step 2011.

In an alternative embodiment of the current invention, vehicle unit 1100 may have a motion sensor 1170 such as an accelerometer that indicates when the vehicle 3 has been moved.

In step 2013, transceiver 1140 of vehicle unit 1100 is able to send a notification to driver's computing device 1300 indicating that the vehicle 3 has been moved.

In still another embodiment of the current invention, vehicle unit 1100 may have a sensor 1170 which can sense markers 1403, 1405 that are placed near a maintenance bay which is used to service the vehicle 3. Vehicle unit 1100 can then send when it is in proximity of markers 1403, 1405. Further, if marker 1403 is placed at the entry of the maintenance bay 1401 and a different marker 1405 is placed at the exit of maintenance bay 1401, vehicle unit 1100 can determine when it enters maintenance bay 1401 and when it exits maintenance bay 1401.

In step 2013 transceiver 1240 sends a notification to driver's computing device 1300 indicating when vehicle 3 enters maintenance bay 1401 and when it exits maintenance bay 1401. In step 2015, this notification may be communicated by cellular transmission, or other known wireless technology and can be in the form of a text message, images, an audible notification, vibration, or other form perceivable to the driver 7.

In step 2017 mechanic 5 performs the maintenance services on the vehicle 3.

In step 2019, mechanic 5 interacts with vehicle unit 1100 through mechanic's computing device 1200 to provide information specific to this maintenance session that is stored with the maintenance history in memory 1160 of vehicle unit 1100. This information will also be provided at the next maintenance session of this vehicle 3.

In step 2021, mechanic's computing device 1200 notifies vehicle unit 1100 that maintenance is complete.

In the optional embodiment described above, a motion sensor 1170 in vehicle unit 1100 indicates that the vehicle has been moved and accordingly sends a notification to driver's computing device 1300

In another optional embodiment described above, the marker sensor 1170 in vehicle unit 1100 senses that it has passed marker 1405 indicating that it has exited the maintenance bay 1401 and the vehicle unit 1100 sends the proper notification to driver's computing device 1300 in step 2023.

In step 2025, the driver's computing device 1300 receives the notification and displays or plays it back to driver 7 indicating that maintenance has been completed. Driver 7 may now walk back to the maintenance area, pay for the service and take vehicle 3. This results in a much more efficient system which can be beneficial to many vehicle drivers.

In an alternative embodiment, the vehicle unit 1100 can communicate with driver's computing device 1300. This now allows the vehicle unit 1100, through the use of an App running on the driver's computing device 1300, to share all of the capabilities of driver's computing device 1300. Therefore, the use of maps, calculation of miles driven, etc. can now be determined by interfacing with the driver's computing device 1300.

The communication can be by any conventional communication, such as Bluetooth. Therefore, when the vehicle unit 1100 senses that it has linked with the driver's computing device 1300, it can continue to calculate mileage driven. It can also indicate mileage driven since the last oil change or other maintenance item. Therefore, the vehicle device 1100 can provide notifications to the driver through driver's computing device 1300 when it is time for various maintenance, such as an oil change, transmission fluid change, coolant change, etc.

Although a few examples have been shown and described, it will be appreciated by those skilled in the art that various changes and modifications might be made without departing from the scope of the invention, as defined in the appended claims.

What is claimed is:

1. A self-contained vehicle maintenance device for assisting a driver of a vehicle with its maintenance, comprising:
a solar panel mounted in a position to receive light energy through a window of the vehicle;
housing for securing the solar panel;
a power source within the housing adapted to receive electronic energy from the solar panel charging it, wherein the power source powers all elements of the vehicle maintenance device;
a memory module within the housing having prestored executable programs and vehicle information;
at least one motion sensor within the housing;
a transceiver within the housing, adapted to communicate with at least one computing device external to the maintenance device;
a processor within the housing, is coupled to the power source, the memory and the transceiver, adapted to run the prestored executable to:
read the at least one sensor to detect if the vehicle has moved;
provide a notification through the transceiver to the driver that the vehicle has moved;
receive a request through the transceiver to provide stored vehicle information;
retrieve requested vehicle information stored in the memory; and
send the retrieved vehicle information through the transceiver to the external computing device.

2. The self-contained vehicle maintenance device of claim 1 wherein the transceiver is at least one of the group consisting of: a LAN wireless communications device, a Bluetooth device, a cellular telephone, and a ‘near field’ communication device.

3. The self-contained vehicle maintenance device of claim 1 wherein the at least one sensor comprises:
an accelerometer for sensing motion of the vehicle;
wherein the processor is adapted to read information indicating movement of the vehicle from the accelerometer and cause the transceiver to provide a notification to the driver that the vehicle has been moved.

4. The self-contained vehicle maintenance device of claim 1 further comprising:
an electronic marker at the entrance and at the exit of the maintenance areas; and
a marker sensor adapted to identify when the vehicle maintenance device is in proximity of one of the electronic markers.

5. The self-contained vehicle maintenance device of claim 1 wherein:
the memory further comprises executable code to update the stored vehicle maintenance information; and
the processor is further adapted to run this executable code to:
receive updated vehicle information from the external computing device through the transceiver;
update the vehicle information stored in memory with the updated vehicle information.

6. The self-contained vehicle maintenance device of claim 1 wherein the vehicle information comprises at least one of:
vehicle year, make, model;
VIN;
oil viscosity recommended;
oil type recommended;
recommended miles between oil changes;
recommended time between oil changes;
vehicle maintenance schedule from the owner's manual;
dates and mileage of previous oil changes;
oil viscosity used;
oil type used;
average time between oil changes;
longest period between oil changes;
dates and mileage of previous vehicle inspections;
dates and mileage of previous emission inspections;
dates, mileage of belt replacements;
dates, mileage of battery replacements;
date and mileage of tire replacement;
tire size;
tire type and wheel replaced;
air filter size;
recommended time and mileage between air filter replacement;
date, mileage of last air filter replacement;
headlight size;
date, mileage of last radiator flush;
recommended time and mileage between transmission fluid replacement;
date, mileage of last transmission fluid replacement;
dates, mileage of previous collisions; and
dates, mileage and descriptions of previous repairs.

7. The self-contained vehicle maintenance device of claim 1 wherein the vehicle information comprises:
a replacement part library indicating parts of the vehicle that are most commonly replaced.

8. A method of maintaining a vehicle comprising the steps of:
attaching a self-contained, self-powered maintenance device to a windshield of the vehicle which may be accessed from outside of the vehicle, capable of:
receiving vehicle information;
storing the vehicle information;
communicating wirelessly with an external computing device to receive a request to retrieve portions of the stored vehicle information;
retrieving the requested vehicle information; and
providing the requested vehicle information to the external computing device.

9. The method of claim 8 further comprising the steps of:
receiving updated vehicle information from the external computing device; and
updating the stored vehicle information with the updated vehicle information.

10. The method of claim 8 further comprising the steps of:
sensing when the vehicle waiting for maintenance is moved; and
employing the maintenance device to send a message to the vehicle driver that the vehicle has moved.

11. The method of claim 8 further comprising the steps of:
providing electronic markers at the beginning and end of a maintenance area which are used to maintain the vehicles;
providing at least one sensor in the vehicle to sense when the vehicle has passed into the maintenance area; and
employing the maintenance device to send a message to the vehicle driver that the vehicle has moved into a maintenance area.

12. The method of claim 8 further comprising the steps of:
sensing when the vehicle has left the maintenance area; and
employing the maintenance device to send a message to the vehicle driver that the vehicle has moved out of the maintenance area.

13. A vehicle maintenance system for assisting a driver of a vehicle with its maintenance, comprising:
an external computing device;
electronic markers marking the maintenance area;
a vehicle mounted unit adapted to communicate wirelessly with the external computing device, comprising:
a solar panel mounted in a position to receive light energy through a window of the vehicle;
a power source adapted to receive electronic energy from the solar panel charging it, wherein the power source powers all elements of the vehicle maintenance system;
a memory module having prestored executable programs and vehicle information;
at least one sensor that can sense the presence of an electronic marker;
a transceiver, adapted to communicate with the external computing device;
a processor adapted to run the prestored executable to:
read the at least one sensor to detect if the vehicle has moved into the maintenance area;
provide a notification through the transceiver to the driver that the vehicle has moved into the maintenance area;
receive a request through the transceiver to provide stored vehicle information;
retrieve requested vehicle information stored in the memory; and
send the retrieved vehicle information through the transceiver to the external computing device.

14. The vehicle maintenance system of claim 13 wherein the processor runs programs in the memory allowing it to:
read the sensor to detect when the vehicle has moved out of the maintenance area; and
provide a notification to the driver that the vehicle has moved out of the maintenance area.

15. The vehicle maintenance system of claim 13 wherein the transceiver is at least one of the group consisting of: a LAN wireless communications device, a Bluetooth device, a cellular telephone, and a ‘near field’ communication device.

16. The vehicle maintenance system of claim 13 wherein:
the memory further comprises executable code to update the stored vehicle maintenance information; and
the processor is further adapted to run this executable code to:
receive updated vehicle information from the external computing device through the transceiver;
update the vehicle information stored in memory with the updated vehicle information.

17. The vehicle maintenance system of claim 13 wherein the vehicle information comprises at least one of:
vehicle year, make, model;
VIN;
oil viscosity recommended;
oil type recommended;
recommended miles between oil changes;
recommended time between oil changes;
vehicle maintenance schedule from the owner's manual;
dates and mileage of previous oil changes;
oil viscosity used;
oil type used;
average time between oil changes;
longest period between oil changes;
dates and mileage of previous vehicle inspections;
dates and mileage of previous emission inspections;
dates, mileage of belt replacements;
dates, mileage of battery replacements;
date and mileage of tire replacement;
tire size;
tire type and wheel replaced;
air filter size;
recommended time and mileage between air filter replacement;
date, mileage of last air filter replacement;
headlight size;
date, mileage of last radiator flush;
recommended time and mileage between transmission fluid replacement;
date, mileage of last transmission fluid replacement;
dates, mileage of previous collisions; and
dates, mileage and descriptions of previous repairs.

18. The vehicle maintenance system of claim 13 wherein the vehicle information comprises:
replacement part library indicating parts of the vehicle that are most commonly replaced.

19. The vehicle maintenance system of claim 18 wherein the replacement part library includes images of the parts.

20. The vehicle maintenance system of claim 13 wherein:
the external computing device is a smartphone of a driver of the vehicle that has the capability to:
communicate with a transceiver;
determine its location, and
determine when it is moving;
monitor how many miles it has traveled when it has been connected to the transceiver; and
the processor is further adapted to receive mileage information from the smartphone and use it for mileage calculations.
